(19) United States
(12) Patent Application Publication
(10) Pub. No.: US 2015/0053448 A1
(43) Pub. Date: Feb. 26, 2015

(54) BRANDING OVERMOLD BUMPER

(71) Applicants: Jason F. BUSSCHAERT, Towson, MD (US); Tylan A. TSCHOPP, Towson, MD (US)

(72) Inventors: Jason F. BUSSCHAERT, Towson, MD (US); Tylan A. TSCHOPP, Towson, MD (US)

(21) Appl. No.: 14/010,058

(22) Filed: Aug. 26, 2013

(51) Int. Cl. B25F 5/02; B23B 45/00; B25B 19/00

(52) U.S. Cl. CPC B25F 5/02; B25B 19/00; B23B 45/001
USPC 173/104; 173/213; 173/217

(57) ABSTRACT

Provided is a power tool including a housing body having a first side and a second side and housing a motor and has an overmold bumper formed on at least the first side of the housing body protruding outwardly from the first side of the housing body such that an outer surface of the overmold bumper defines an outermost point of the power tool in a direction orthogonal to a motor axis of the power tool. The overmold bumper has a longitudinal span of at least 60% of a total length of the housing body in a direction along the motor axis, is formed of an elastomeric material and includes raised indicia.

### BACKGROUND OF THE INVENTION

1. Field of the Invention

Aspects of the present application relate to an external bumper mounted on a housing of a power or hand tool.

2. Description of the Related Art

The portability of hand held power tools allows them to be employed in various environments. One possible environment is the interior of a home, which may contain delicate surfaces, such as furniture, electronics, and flooring. However, the operator of the power tool may inadvertently damage delicate surfaces of the surroundings by recklessly placing or dropping the tool on a surface. Furthermore, the tool may bump into nearby objects while in use and cause damage.

Marring of an opposing surface occurs when the main body of the tool, which is relatively heavy and made of a hard material, comes into contact with a comparatively softer surface. Examples include scratches, dents, and scuffs left on a surface due to contact with sharp edges of the hard plastic body, exposed assembly screws, or other metal components on the external body of the tool and the like. Marring is undesirable because refinishing a delicate surface, such as fine furniture, is expensive.

It is an aspect of the present application to solve the abovementioned problems by providing a non-marring overmold bumper on the exterior housing of the power tool.

Additionally, it is another aspect to use the overmold bumper to display indicia identifying the manufacturer or retailer of the tool using the non-marring overmold bumper mounted on the exterior housing of the power tool. Overmold bumpers comprised of indicia allow low-cost brand execution and large branding for high visibility at retail sale of the product.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

According to an aspect of the invention, a power tool is provided. The power tool comprises a housing body having a first side and a second side and housing a motor and has an overmold bumper formed on at least the first side of the housing body protruding outwardly from the first side of the housing body such that an outer surface of the overmold bumper defines an outermost point of the power tool in a direction orthogonal to a motor axis of the power tool. The overmold bumper has a longitudinal span of at least 60% of a total length of the housing body in a direction along the motor axis, is formed of an elastomeric material and comprises raised indicia.

According to another aspect, the overmold bumper is positioned in line with the motor axis. The overmold bumper may include at least one strip extending in a direction parallel to the motor axis. The at least one strip extends substantially continuously across the first side of the housing in an extending direction for at least 60% of the length of the housing body along the motor axis.

According to another aspect, the overmold bumper may include a plurality of strips arranged in parallel such that at least one gap is formed between the plurality of strips that extends substantially in the direction parallel to the motor axis.

According to another aspect, the overmold bumper includes a plurality of segments on a first side of the housing body. The overmold bumper may be provided on a rear corner of the housing body.

According to another aspect, the overmold bumper may comprise a first overmold bumper mounted on the first side of the housing and a second overmold bumper mounted on the second side of the housing. Additionally, the overmold bumper may be formed as a monolithic structure.

According to another aspect, the housing of the power tool comprises a clamshell housing having a first clamshell part including the first side and a second clamshell part including the second side. The overmold bumper has a longitudinal span of at least 60% of a length of the first clamshell part along the motor axis. The overmold bumper may also include raised indicia extend beyond at least the first side of the housing body. The power toll may be a drill or an impact driver.

According to another aspect, a power tool is provided and comprises a housing body having a first side and a second side. An overmold bumper is mounted on the first side and second side of the housing body protruding respectively outwardly from the sides of the housing body such that an outer surface of the overmold bumper defines an outermost point of the power tool in a direction orthogonal to a motor axis of the power tool. The overmold bumper comprises raised indicia extending beyond the sides of the housing body and has a longitudinal span of at least 60% of a total length of the housing body in a direction along the motor axis. The overmold bumper may be substantially continuous in the direction along the motor axis and be formed of an elastomeric material.

According to another aspect, a power tool is provided and includes a housing comprising a first clamshell half and a second clamshell half; an electric motor housed in the housing capable of providing rotary motion; a trigger for activating the motor; and an elastomeric bumper provided on at least one of the first clamshell half and the second clamshell half. The elastomeric bumper comprises raised indicia which are located along a longitudinal axis of at least one of the first and second clamshells. The elastomeric bumper may comprise raised indicia which encompass an area having a longitudinal span of at least 60% of a length of at least one of the first clamshell half and the second clamshell half along a motor axis. The longitudinal axis of the at least one of the first and second clamshells is parallel to a longitudinal axis of the motor. The power tool may also include a handle which is substantially perpendicular to an axis of the motor. The power toll may be one of a drill and an impact driver.

### BRIEF DESCRIPTION OF THE DRAWINGS

The above and other features and aspects of the present application will become more apparent by describing in detail non-limiting, exemplary embodiments thereof with reference to the attached drawings, which are not necessarily drawn to scale, and wherein:

FIG. 1 is a side view of a power tool and overmold bumper in accord with a first embodiment.

FIG. 2 is another side view of a power tool and overmold bumper in accord with a first embodiment.

FIG. 3 is an oblique view of the power tool and overmold bumper in accord with the first embodiment.

FIG. 4 is a front view of the power tool and overmold bumper of the first embodiment.

FIG. 5 is a back view of the power tool and overmold bumper of the first embodiment.

FIG. 6 is a top view of the power tool and overmold bumper of the first embodiment.

FIG. 7 is a side view of a power tool and overmold bumper in accord with a second embodiment.

FIG. 8 is a side view of a power tool and overmold bumper in accord with a third embodiment.

FIG. 9 is an oblique view of the power tool and overmold bumper in accord with the third embodiment.

FIG. 10 is a front view of the power tool and overmold bumper of the third embodiment.

### DETAILED DESCRIPTION OF THE EXEMPLARY EMBODIMENTS

Hereinafter the non-limiting exemplary embodiments of the present invention will now be described more fully with reference to the accompanying drawings.

As used in the specification and claims, the term “indicia” refers to any mark intended to convey information to the viewer. For example, indicia may include letters, numerals, symbols, characters, designs, logos, pictures, decorations, or combinations thereof, among other means of relaying information to the viewer.

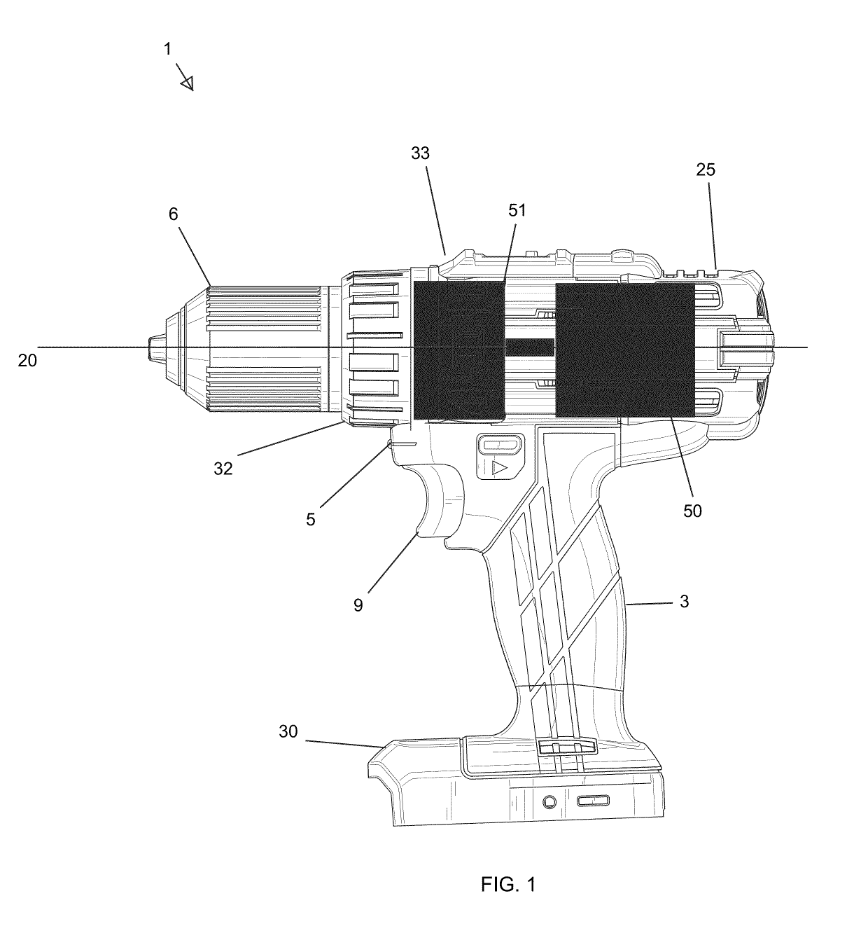

FIGS. 1-6 show features of the overmold bumper in accord with a first embodiment of the present application. FIGS. 1-6 show multiple views of a power tool, in this case a drill 1. The present application is also applicable to other power tools such as an impact driver, nail gun or staple gun, for example. The drill 1 has a housing 5 which internally houses a motor 50 and a motor transmission 51. The motor 50 is operable using DC current from a battery pack (not shown) or other power source and controlled by a variable speed trigger 9. Motor 50 and motor transmission 51 are mounted in housing 5 and are connected via a motor output spindle (not shown) to chuck 6 for rotation of the chuck 6. The motor transmission 51 of the present embodiment is a two-speed transmission which can be toggled between two speeds by selector 52. The drill 1 also includes a clutch and a clutch ring to adjust the clutch setting. The drill 1 may be a battery-powered device, powered by an electric cord, or may be pneumatically driven, for example. The drill 1 also has a front portion 33 and has a rear portion 25.

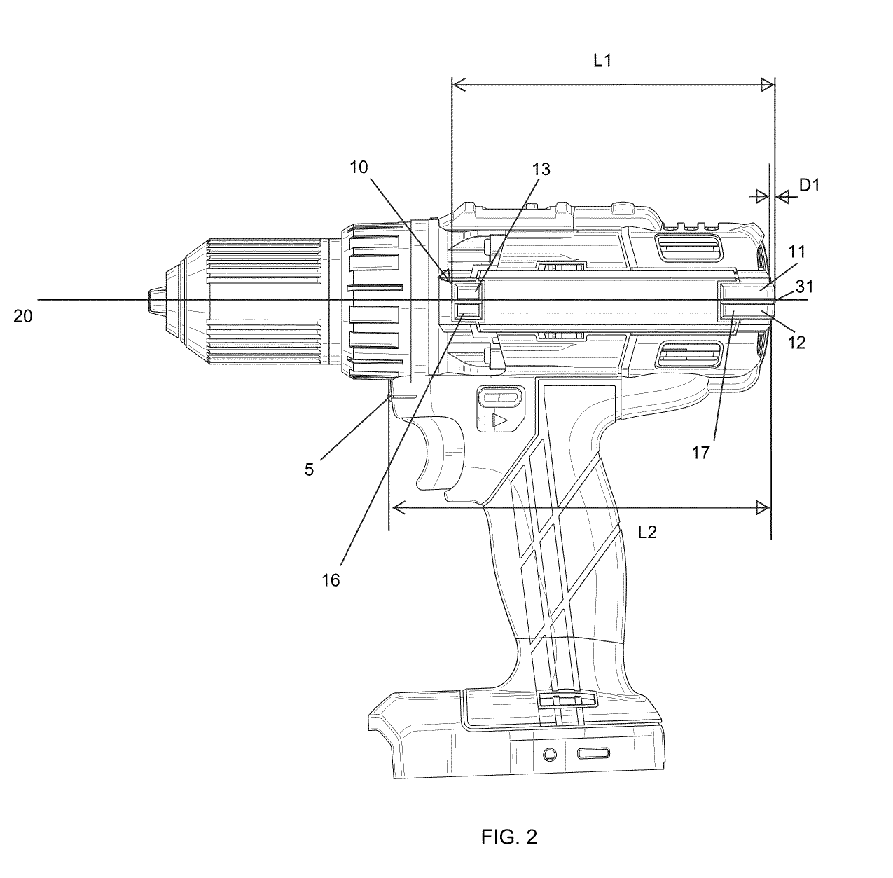

As shown in FIG. 2, an overmold bumper 10 is disposed on the outer surface of the housing 5. The overmold bumper 10 is positioned in line with the motor axis 20, so as to be aligned with the center of gravity of the motor 50, which is disposed in the interior of the drill 1. The overmold bumper 10 is preferably provided with a span of at least 60% of the length of the housing 5, such that the following relationship is satisfied:

L1≧0.6×L2
where L1 is the span of the overmold bumper 10 in a direction parallel to the motor axis 20 from a front end to a rear end, and L2 is the total length of the housing 5 in a direction parallel to the motor axis 20 from a front end to a rear end. It may be further beneficial that the overmold bumper 10 is provided with a span of at least 70% of the length of the housing 5 and further beneficial if it is provided with a span of at least 80% of the length of the housing 5.

The overmold bumper 10 is configured such that the outer surface 13 of the overmold bumper 10 is a contact surface defining the outermost point of contact with the surroundings when the drill 1 is, for example, placed on its side. By forming the overmold bumper 10 with a thickness such that it protrudes beyond the housing 5 in a direction extending normal to a side of the drill 1, the overmold bumper 10 may prevent the housing 5 from coming into contact with a surface of the surrounding environment, for example a countertop. The motor housing portion of a power tool is typically a substantially cylindrical shape, encasing the substantially cylindrical motor 50. Therefore, the overmold bumper 10 defines an outermost point of the drill 1 in a direction orthogonal to a motor axis 20 of the drill 1.

The housing 5 of the drill 1 is typically made of a rigid, high strength plastic. Additionally, a hand held drill comprising a motor and various metal parts, such as a chuck, bearings, transmission and shifter assembly, and drill bits, is relatively heavy. Accordingly, if the drill were recklessly placed on a surface after use, the surface may be marred due to the impact of the drill with the surface. An advantage of the overmold bumper 10 is that in the event of being placed on a delicate surface, such as a countertop or soft wood, the overmold bumper 10 will deform to absorb impact to prevent damage to the surface.

As shown in FIGS. 2-6, the overmold bumper 10 extends in a direction parallel to the motor axis 20. The overmold bumper 10 may have a trapezoidal shape in a cross section taken along the longitudinal direction. When using the trapezoidal shape, the base portion adjacent to the housing 5 is wider than the width of the outer surface 13. However, the present invention is not so limited and a strip having any cross sectional shape may be used. In the exemplary embodiment of FIG. 2, the overmold bumper 10 comprises an outer surface 13 having a gap 31 between the two strips, i.e., first strip 11 and second strip 12. The gap portion reduces the amount of material required to manufacture the overmold bumper, thus reducing cost. In the embodiment shown in FIG. 2, the overmold bumper 10 is provided with a one strip 11 and a second strip 12.

To conserve material, the overmold bumper 10 may be comprised of a plurality of discrete segments, so long as the span L1 from a front end to a rear end of the overmold bumper 10 is at least 60% of the total length L2 of the housing 5. In the embodiment shown in FIG. 2, the overmold bumper 10 including the first strip 11 and second strip 12 are provided in two segments, a front segment 16 and rear segment 17, on one side of the drill 1 such that first strip 11 and second strip 12 are discontinuous. However, in other embodiments, the overmold bumper 10 may be a single piece such that the first strip 11 and second strip 12 are continuous on one side of the drill 1.

The overmold bumper 10 is provided with a longitudinal span L1 of at least 60% the length of the housing 5 in order to improve the stability of the drill 1 in the direction of the motor axis 20 when resting on its side. A drill provided with a bumper spanning a short length, for example, may wobble in the direction along the motor axis when resting on its side, which increases the possibility of other parts of the drill besides the bumper coming into contact with and therefore marring the surface of the surroundings. Particularly, an overmold bumper provided with a longitudinal span of at least 60% the length of the housing 5 ensures that a chuck 6 does not lean against a surrounding surface.

The overmold bumper 10 defines a bumper depth D1, as illustrated in FIG. 2, from the rearward most part of the rear portion 25 of the housing 5 to the outer surface 13 of the overmold bumper 10. The depth D1 is preferably 0.8 to 1.2 mm in thickness, but most preferably 1 mm.

The overmold bumper 10 is preferably composed of rubber or other elastomeric material having resilience and shock absorbing properties. A rubber having a durometer of an appropriate value may be used as dictated by the tool weight and hardness of the rigid plastic housing of the power tool. The durometer of the material preferably ranges from 45 to 70 shore A, but is most preferably 50 shore A. Aside from rubber, a similarly flexible material may be employed for improved impact absorption, such as foam.

Additional advantages of using an elastomeric material are as follows. First, an elastomeric material typically has a high coefficient of static friction compared to rigid plastic of the housing. In a situation where the power tool is placed on a sloped surface, the overmold bumper composed of an elastomeric material will prevent the tool from sliding down the slope. Next, an elastomeric covering on the power tool enhances the grippability of the tool, especially when the user places his non-trigger hand on the housing for providing additional thrust or support, for example.

The elastomeric covering, including the overmold bumper 10, may be provided by injection molding or other manufacturing process known in the art.

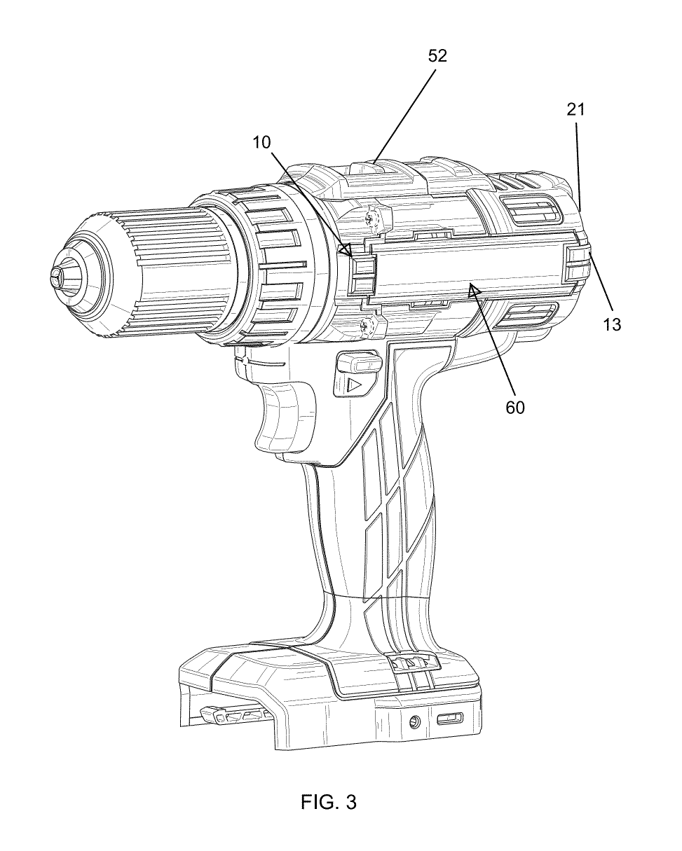

FIG. 3 shows an exemplary embodiment of a drill provided with an overmold bumper 10 such that the rear corner 21 of the tool is covered by the overmold bumper 10. Since the extremities of the drill are most likely to come into contact with other objects, it is advantageous to dispose the overmold bumper 10 such that it covers a corner or other extremity of the drill.

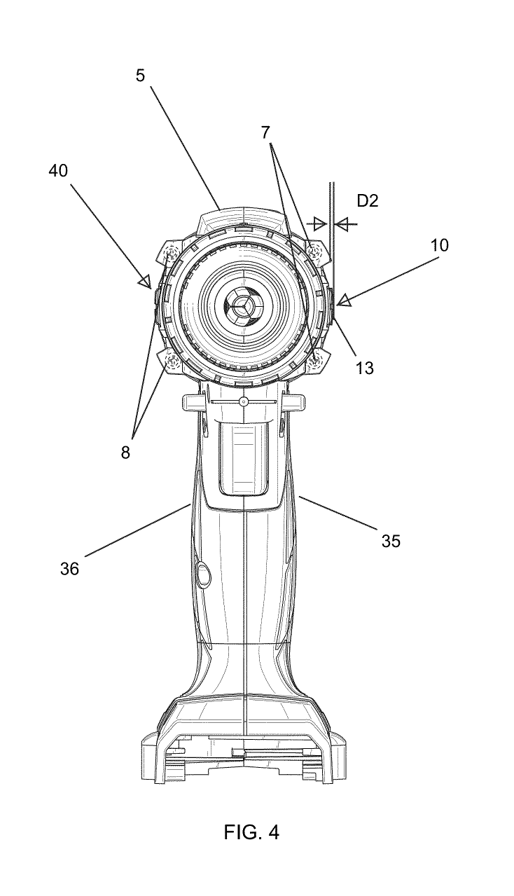

FIG. 4 shows an exemplary embodiment of a drill provided with an overmold bumper 10 and a complimentary overmold bumper 40 disposed on the opposite side of the drill. Since the drill has two sides and may be symmetric, it is advantageous for bumpers to be disposed on both a first side 35 and a second side 36 of the housing 5 such that the drill may be laid down on either side without marring the surface of the surroundings. The housing 5 may be a clamshell comprising the first side 35 and second side 36, which are substantially mirror images of each other. The sides of the housing 5 are not limited to a clamshell type and each side may be comprised of multiple pieces that encase the motor 50 and transmission 51.

The bumpers define a bumper depth D2, as illustrated in FIG. 4, from the plane of housing extremities 7 to the outer surface 13 of the overmold bumper 10 or from housing extremities 8 to complimentary overmold bumper 40. The bumper depth D2 may be determined according to the expected deformation of the overmold bumper 10 or for aesthetic reasons, for example, so long as the overmold bumper 10 protrudes beyond the plane of housing extremities 7 so as to be the outermost point of contact. Additionally, the height of the one strip 11 and second strip 12 or the front segment 16 and rear segment 17 may be the same or different so as to define different bumper depths measured from the plane of housing extremities 7.

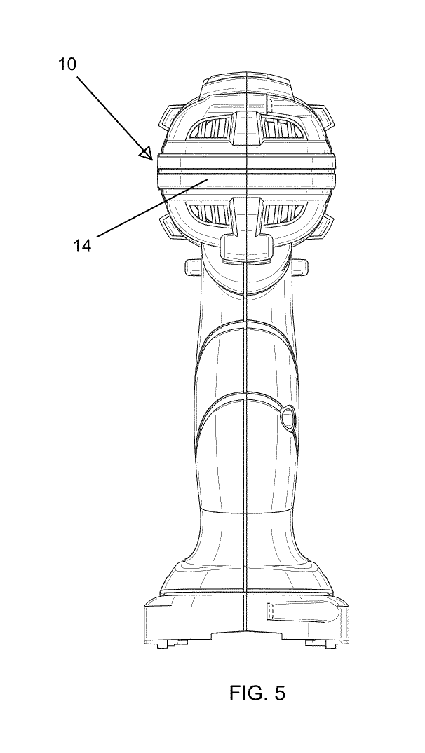

FIG. 5 shows the overmold bumper 10 arranged such that the bumper material substantially wraps around the back part 14 of the housing 5. The bumper may be a single piece such that overmold bumper 10 and complimentary overmold bumper 40 are molded together as a monolithic structure, or may remain separate pieces.

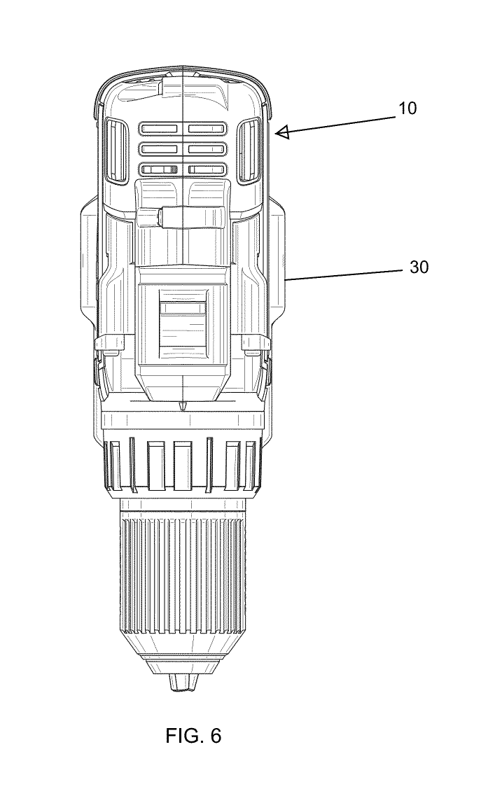

FIG. 6 shows a top view of the drill with overmold bumper 10. In an exemplary embodiment, additional bumpers may be provided on a battery pack (not shown) attached to the bottom part 30 of the drill. Alternatively, bumpers may be provided directly on the bottom part 30. When bumpers are also provided at the bottom part 30 of the drill, the drill will be completely prevented from contacting nearby surfaces, since the overmold bumpers according to this embodiment will engage the surface and keep the housing 5 separate from the surface.

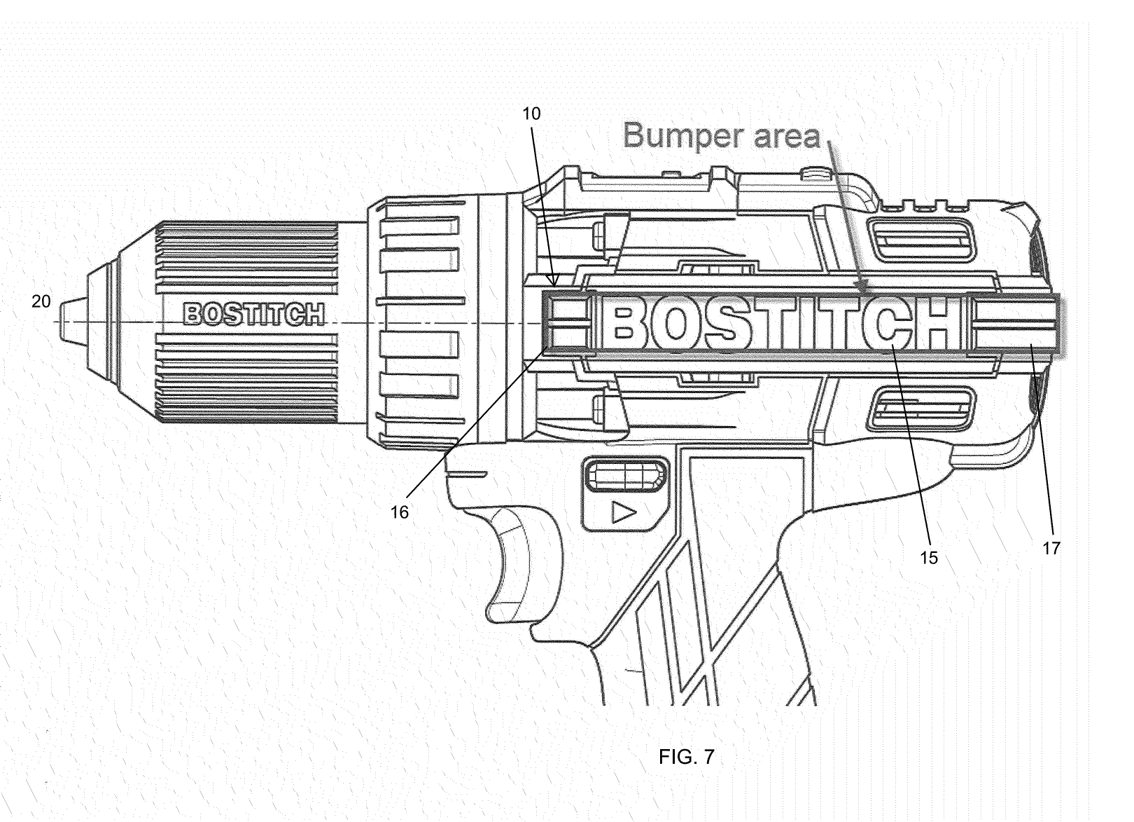

A power tool and overmold bumper according to the second embodiment is shown in FIG. 7. The overmold bumper 10 has similar material characteristics as the first embodiment as described above. However, the overmold bumper 10 of the second embodiment is provided with raised indicia 15 formed using the overmold bumper. The raised indicia 15 may include product branding and the like. The raised indicia 15 may be provided as letters or symbols disposed directly on the surface of the housing 5, similar to the process described above for the one strip 11 and second strip 12. Additionally, the height of the raised indicia 15 may be the same or different as the one strip 11 and second strip 12, or front segment 16 and rear segment 17. As illustrated in FIG. 7, the raised letters of the raised indicia 15 have the same height as the front bumper segment 16 and rear bumper segment 17 so as to be flush with the outer surface 13 and defining a flat contact surface.

The raised indicia 15 may be provided in addition to front segment 16 and rear segment 17, as illustrated in FIG. 7, or may be augmented by any number of further bumper segments provided on the housing 5. However, the raised indicia 15 may also be provided alone, solely comprising the overmold bumper 10.

The raised indicia 15 (with or without additional bumper segments) define the region labeled “Bumper area”, as shown in FIG. 7, which has a longitudinal span equal to L1. The raised indicia 15 may extend continuously in the direction along the motor axis 20 so as to significantly cover the bumper area longitudinally. However because the raised indicia may be composed of discrete letters, there may be gaps between the individual overmold bumper sections making up the letters. Even with gaps, the overmold bumper 10 comprising raised indicia 15 may substantially cover the bumper area in the longitudinal direction.

Disposing raised indicia in the bumper area has several advantages as summarized as follows. For example, executing indicia in the overmold bumper material satisfies the structural requirement for providing a protective non-marring bumper surface, while simultaneously displaying marketing information on the product. That is, low cost product branding can be effected by eliminating the requirement of separate manufacturing of the indicia and packaging the indicia in another location on the tool. Additionally, indicia executed in an overmold bumper, when the bumper span defines at least 60% of the length of the housing, provides a large area for the indicia to be displayed, maximizing visibility. Raised indicia composed of a three-dimensional shape additionally provide enhanced definition and visibility. Further, in contrast to indicia typically provided by printed markings on the exterior surface of a product, raised indicia are less susceptible to being rubbed away and the indicia disappearing after an extended period of use.

The illustrated embodiments define raised indicia on the side faces of a power tool; however, further embodiments of the present invention may define raised indicia on the back face, for example at back part 14.

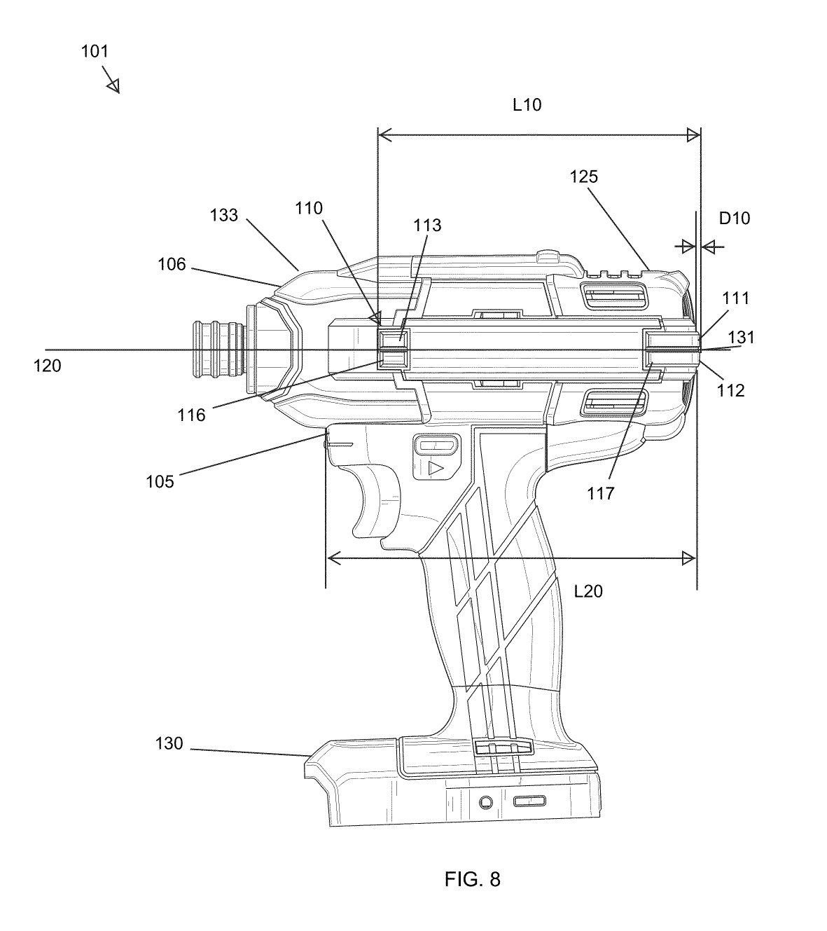

FIGS. 8-10 show features of the overmold bumper in accord with the third embodiment of the present application. FIGS. 8-10 show multiple views of a power tool, in this case an impact driver 101. Aspects of this embodiment are similar to the first embodiment with the exception that this embodiment describes a power tool in the form of an impact driver.

The impact driver 101 has a housing 105, which internally houses a motor. An overmold bumper 110 is disposed on the outer surface of the housing 105. The impact driver 101 also has a front portion 133 and has a rear portion 125. There may be a nose cone 106 disposed at the front of the impact driver.

The overmold bumper 110 is positioned in line with the motor axis 120, so as to be aligned with the center of gravity of the motor, which is disposed in the interior of the impact driver.

The overmold bumper 110 is provided with a span of at least 60% of the length of the housing 105, such that the following relationship is satisfied:

L10≧0.6×L20
where L10 is the span of the overmold bumper 110 in a direction parallel to the motor axis 120 from a front end to a rear end, and L20 is the total length of the housing 105 in a direction parallel to the motor axis 120 from a front end to a rear end.

The overmold bumper 110 is configured such that the outer surface 113 of the overmold bumper 110 is a contact surface defining the outermost point of contact with the surroundings when the impact driver is, for example, placed on its side.

The overmold bumper 110 extends in a direction parallel to the motor axis 120. The overmold bumper 10 may have a trapezoidal shape in a cross section taken along the longitudinal direction but is not so limited. The overmold bumper 110 may comprise an outer surface 113 having a gap 131 between two strips, i.e., first strip 111 and second strip 112. The overmold bumper 110 may be comprised of a plurality of discrete segments, so long as the span L10 from a front end to a rear end of the overmold bumper 110 is at least 60% of the total length L20 of the housing 105. The overmold bumper 110 including the first strip 111 and second strip 112 may be provided in two segments, a front segment 116 and rear segment 117, on one side of the impact driver such that first strip 111 and second strip 112 are discontinuous. However, in other embodiments, the overmold bumper 110 may be a single piece such that the first strip 111 and second strip 112 are continuous on one side of the impact driver.

The overmold bumper 110 defines a bumper depth D10, as illustrated in FIG. 8, from the rearward most part of the rear portion 125 of the housing 105 to the outer surface 113 of the overmold bumper 110.

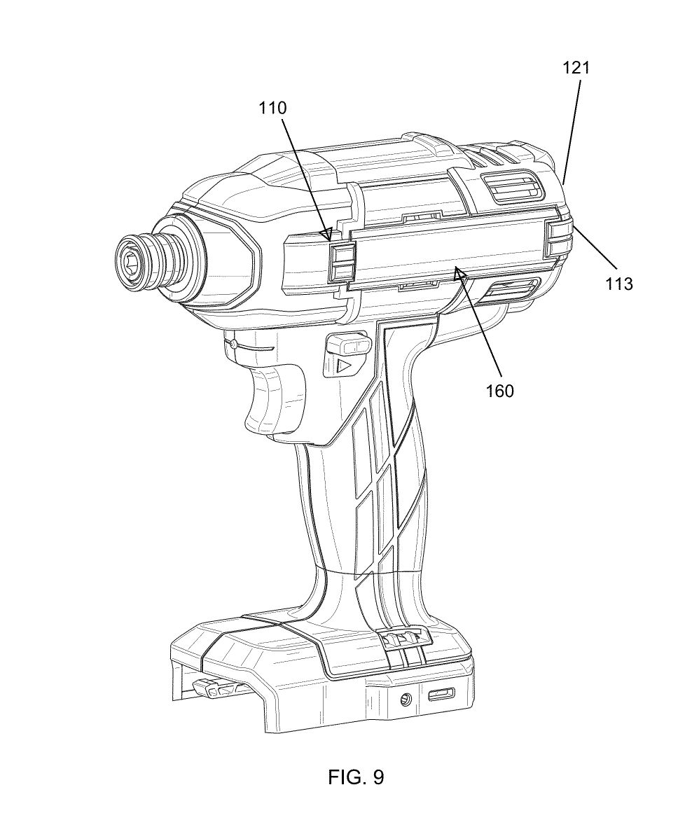

FIG. 9 shows an exemplary embodiment of an impact driver 101 provided with an overmold bumper 110 such that the rear corner 121 of the tool is covered by the overmold bumper 110.

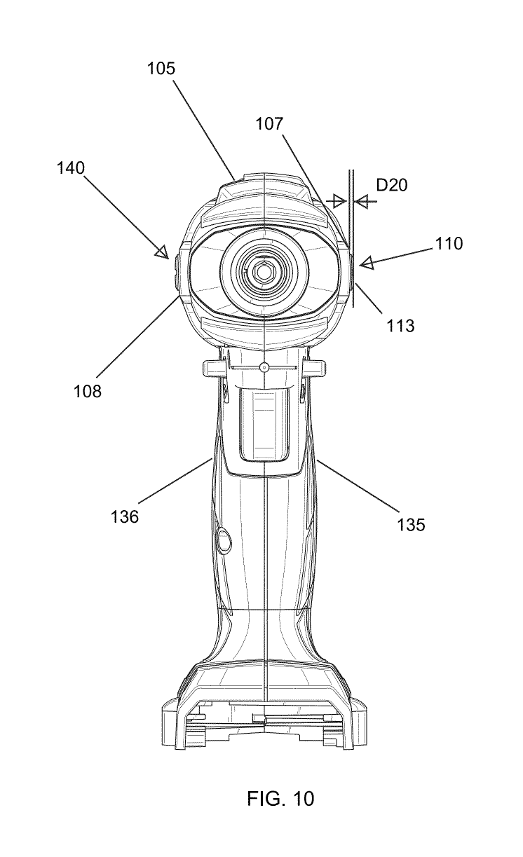

FIG. 10 shows an exemplary embodiment of an impact driver 101 provided with an overmold bumper 110 and a complimentary overmold bumper 140 disposed on the opposite side of the impact driver 101. Since the impact driver 101 has two sides and may be symmetric, it is advantageous for bumpers to be disposed on both a first side 135 and a second side 136 of the housing 105. The housing 105 may be a clamshell comprising the first side 135 and second side 136, which are substantially mirror images of each other.

The bumpers define a bumper depth D20, as illustrated in FIG. 9, from the plane of housing extremities 107 to the outer surface 113 of the overmold bumper 110 or from housing extremities 108 to complimentary overmold bumper 140.

Similar to the second embodiment, in a fourth embodiment of the application, the overmold bumper 110 may be provided with raised indicia (not shown) formed using the overmold bumper 110. The raised indicia may include product branding and the like. The raised indicia may be disposed in an indicia space 160, as illustrated in FIG. 9.

While this invention has been particularly shown and described with reference to exemplary embodiments thereof, the above description should be considered in as illustrations of the exemplary embodiments only and are not for purposes of limitation. Therefore, the scope of the invention is defined not by the detailed description of the invention but by the appended claims, and all differences within the scope will be construed as being included in the present invention. Additionally, the features described in the various embodiments are not exclusive in that a feature of one embodiment may be incorporated into another embodiment.

What is claimed is:

1. A power tool comprising:
a housing body having a first side and a second side and housing a motor;
an overmold bumper formed on at least the first side of the housing body protruding outwardly from the first side of the housing body such that an outer surface of the overmold bumper defines an outermost point of the power tool in a direction orthogonal to a motor axis of the power tool; wherein
the overmold bumper has a longitudinal span of at least 60% of a total length of the housing body in a direction along the motor axis; and
the overmold bumper is composed of an elastomeric material and comprises raised indicia.

2. The power tool according to claim 1, wherein
the overmold bumper is positioned in line with the motor axis.

3. The power tool according to claim 1, wherein
the overmold bumper includes at least one strip extending in a direction parallel to the motor axis.

4. The power tool according to claim 3, wherein
the at least one strip extends substantially continuously across the first side of the housing in an extending direction for at least 60% of the length of the housing body along the motor axis.

5. The power tool according to claim 3, wherein
the overmold bumper includes a plurality of strips arranged in parallel such that at least one gap is formed between the plurality of strips that extends substantially in the direction parallel to the motor axis.

6. The power tool according to claim 1, wherein
the overmold bumper includes a plurality of segments on a first side of the housing body.

7. The power tool according to claim 1, wherein
the overmold bumper is provided on a rear corner of the housing body.

8. The power tool according to claim 1, wherein
the overmold bumper comprises a first overmold bumper mounted on the first side of the housing and a second overmold bumper mounted on the second side of the housing.

9. The power tool according to claim 1, wherein
the overmold bumper is formed as a monolithic structure.

10. The power tool according to claim 1, wherein the housing is a clamshell housing comprising a first clamshell part including the first side and a second clamshell part including the second side; and
wherein the overmold bumper has a longitudinal span of at least 60% of a length of the first clamshell part along the motor axis.

11. The power tool according to claim 1, wherein
the raised indicia extend beyond at least the first side of the housing body.

12. The power tool according to claim 1, wherein the power tool is a drill.

13. The power tool according to claim 1, wherein the power tool is an impact driver.

14. A power tool comprising:
a housing body having a first side and a second side;
an overmold bumper mounted on the first side and second side of the housing body protruding respectively outwardly from the sides of the housing body such that an outer surface of the overmold bumper defines an outermost point of the power tool in a direction orthogonal to a motor axis of the power tool; wherein
the overmold bumper comprises raised indicia extending beyond the sides of the housing body; and
the overmold bumper has a longitudinal span of at least 60% of a total length of the housing body in a direction along the motor axis; and
the overmold bumper is substantially continuous in the direction along the motor axis; and
the overmold bumper is composed of an elastomeric material.

15. A power tool comprising:
a housing comprising a first clamshell half and a second clamshell half;
an electric motor housed in the housing capable of providing rotary motion;
a trigger for activating the motor; and
an elastomeric bumper provided on at least one of the first clamshell half and the second clamshell half;
wherein the elastomeric bumper comprises raised indicia which are located along a longitudinal axis of at least one of the first and second clamshells.

16. The power tool according to claim 15, wherein the elastomeric bumper comprises raised indicia which encompass an area having a longitudinal span of at least 60% of a length of at least one of the first clamshell half and the second clamshell half along a motor axis.

17. The power tool according to claim 16, wherein the longitudinal axis of the at least one of the first and second clamshells is parallel to a longitudinal axis of the motor.

18. The power tool according to claim 15, further including a handle which is substantially perpendicular to an axis of the motor.

19. The power tool according to claim 18, wherein the power tool is one of a drill and an impact driver.

20. The power tool according to claim 15, wherein the first and second clamshell halves are made of rigid plastic.
